(19) United States
(12) Patent Application Publication
(10) Pub. No.: US 2026/0307169 A1
(43) Pub. Date: Oct. 8, 2026

(54) LASER MACHINING SYSTEM FOR A TIMEPIECE COMPONENT AND LASER MACHINING PROCESS

(71) Applicant: ROLEX SA, Geneva (CH)

(72) Inventors: Benjamin Babrel, Bègles (FR); Bruno Chassagne, Pessac (FR); Pierre Di Luna, Veigy-Foncenex (FR); Alexandre Oliveira, Amancy (FR); Aurélien Sikora, Talence (FR)

(73) Assignee: ROLEX SA, Geneva (CH)

(21) Appl. No.: 19/637,251

(22) Filed: Apr. 2, 2026

(30) Foreign Application Priority Data
Apr. 4, 2025 (EP) 25168473.4

(51) Int. Cl. B23K 26/064; B23K 26/0622; B23K 26/082; B23K 26/38; B23K 101/00

(52) U.S. Cl. CPC B23K 26/0648; B23K 26/0622; B23K 26/0821; B23K 26/38; B23K 2101/00

(57) ABSTRACT

A system (1) for laser machining, specifically cutting, a component, includes a source (L) for emitting a pulsed laser beam, a first subsystem (LDO) for adjusting the polarization of the laser beam, at least a first and a second deflector (EOD), having non-parallel axes, a second subsystem (LOO) for adjusting the polarization of the beam exiting the deflectors, a deflector control subsystem (GRP), a synchronization subsystem (DG) for synchronizing the laser beam emission source with the control subsystem (GRP), a first focusing subsystem (F) comprising a first lens (FT) and positioned after the second subsystem for adjusting the polarization of the beam exiting the deflectors, a subsystem for simultaneously controlling the divergence and deflection of the laser beam at the output of the deflectors, as well as a second focusing subsystem (RF) and a propagation module (SPF), the sub-system for simultaneous control of divergence and deflection being positioned between the output of the deflectors and the first focusing sub-system (FT). A beam stabilization subsystem (MS) is positioned downstream of the laser source and/or upstream of a first deflector (AOD), the system being configured to create a precession of the laser beam.

### CROSS-REFERENCE TO RELATED APPLICATION

This application claims priority of European patent application No. EP25168473.4 filed Apr. 4, 2025, the content of which is hereby incorporated by reference herein in its entirety.

### FIELD OF THE INVENTION

The invention relates to a laser machining system for a timepiece component, or more generally any other component, even outside the field of watchmaking. The invention also relates to a laser machining process.

### BACKGROUND ART

Laser machining is used in microtechnology for the production of components, particularly timepiece components. In particular, femtosecond lasers enable the precise machining of small components at very high speeds without thermal damage. However, traditional approaches to focusing and guiding laser beams make it difficult to produce components with straight flanks along a cutting line. The conical shape of the laser beam at the focal point, the non-uniform light intensity profile of the laser beam, and the non-linearity of the ablation depth as a function of light intensity tend to cause the flanks to tilt by a few degrees.

To remedy this, a recognized approach involves manipulating the workpiece and/or a laser machining head using a five-axis mechanical system. This technique allows the workpiece and/or the laser head to be tilted to compensate for the taper at the focal point on the remaining side of the workpiece.

Another widespread process is laser machining by precession, i.e., using a laser beam that is tilted and rotated about an axis by opto-mechanical means. The focusing of this rotating beam creates a specific focal point. The laser beam is slightly tilted relative to the machining plane in the opposite direction to compensate for the taper, and its focal point describes a circular trajectory. This circle forms the base of a cone of which the apex is located above the machining plane. Consequently, the length of the machining path increases, as does the volume of material removed.

In both of the previously described cases, the machining feed rate is significantly reduced. In the first process, this reduction in feed rate is due to the limited travel speed of the tables or machining heads. In the second process, additional time is required for the beam to complete the path around the circumference of the circle. Furthermore, the stability of an opto-mechanical system containing optical elements rotating at high speeds—up to 30,000 revolutions per minute or 500 Hz—is prone to rapid degradation and is often accompanied by harmful vibrations.

In conventional femtosecond laser machining cases, femtosecond lasers enable material removal by ablation while maintaining minimal thermal load. To achieve this, the energy delivered per pulse is kept just above the ablation threshold. The beam is focused on the workpiece to create a round focal spot. This requires overlap between successive pulses to ensure uniform material removal. Given the shallow ablation depth, multiple passes along the cutting contour are necessary.

The overlap between successive pulses is typically 50%-75%. The focal spot feed rate with this overlap is

vmax=flaser×dfocal×(1−arec), where
flaser is the laser pulse frequency,
dfocal is the focal spot diameter,
arec is the degree of overlap between consecutive pulses.

Typically, arec=0.75, dfocal=10 μm, flaser=1-10 MHz, which yields a vmax value between 2.5 m/s and 25 m/s. The latter corresponds to the maximum speed of galvanometric systems.

In cases of laser machining with a precessing beam, as shown in FIG. 1, the beam is tilted at an angle α relative to the normal N of a workpiece S to be machined. In order to achieve the desired taper on both flanks regardless of the machining direction, the tilted beam is rotated around the precession axis AP. A BFI (Best Focus Individual) plane is defined as the instantaneous focal plane of the laser beam. The laser's trace in this BFI plane has a circular shape. The beam itself describes a cone in space around the AP axis, the apex of which must lie above the BFI plane to achieve flanks with the desired taper.

The principle of overlap between successive pulses translates, for precession machining, into the overlap between two successive precession circles. The precession frequency fprec defines the maximum machining feed rate according to the formula:

vmax=fprec×dfocal×(1−arec).

With fprec=500 Hz (30,000 rpm), typical of prior art rotary optical systems,
arec=0.75,
dfocal=10 μm,
we obtain vmax=0.00125 m/s=1.25 mm/s. This feed rate is well below the maximum speed of a galvanometric system estimated above.

When the diameter of the opening on the side where the laser beam enters the workpiece is greater than that on the output side, this is referred to as positive taper. The taper is considered zero when the two diameters are identical, thereby giving the machined flanks a straight shape: the geometric shape of the machining is then a small cylinder in static drilling mode. Conversely, the taper becomes negative if the diameter of the opening on the input side is smaller than that of the beam's output.

A rotary afocal system for precession laser machining is known from document WO2016/024069A1. The laser beam is shifted parallel to its initial axis by an arrangement of two off-axis lenses that are rotated. This shift is transformed by a focusing lens at an angle of inclination that can compensate for the taper of the flanks of a hole or a cutting path.

Document EP3700705A1 discloses a process for scanning the laser beam up to 5 or 6 axes (5D or 6D) with path interpolation between reference points. The 5 or 6 axes comprise:
3 position coordinate axes (x, y, z) of the focal point,
the angles α and β of the laser beam's inclination relative to the path, and
the angle of the laser beam's linear polarization.

Two 4D (x, y, α, β) control subsystems for the laser beam, based on four uniaxial galvanometer mirrors or two biaxial galvanometer mirrors, are mentioned as examples. Control in the z-axis is provided by a focusing lens or by the workpiece holder.

Document EP3195041A1 discloses a system that transforms a laser beam using an inclined mirror rotated about its axis of symmetry. To compensate for the beam's angular deviation, a retro-reflector reflects it back onto the mirror, which, through a second reflection, returns the beam to a path that is parallel to and offset from the initial beam. As a result, the laser beam traces a circle centered around an axis. This circular motion is then converted by a focusing lens into a precession motion that can compensate for the taper of the flanks of a hole or a cutting path.

A rotary opto-mechanical precession system for performing laser machining with adjustable flank taper is known from document WO2012035031A1. The element regulating the circular deflection of the laser beam is an inclined plate with parallel surfaces.

Document US20160250714A1 discloses a laser processing system comprising:
1) a first positioning system for imposing a first relative movement of a laser beam axis along a beam path relative to a workpiece;
2) a processor for determining a second relative movement of the laser beam axis with a reduced amplitude compared to the first movement (dithering);
3) a second positioning system for imposing the second relative movement; and
4) a laser source for emitting laser beam pulses.

The first system is a galvanometric deflector and the second system is an acousto-optic deflector (AOD). The application aims to protect the high-speed machining of conductive tracks with a variable cross-section and variable geometry for semiconductor chip encapsulations (semiconductor packaging).

Relay lenses are proposed to direct the beam after the second system (AOD) toward the first galvanometric system. These lenses can introduce aberrations and prevent proper focusing of the laser beam. Consequently, machining time may be increased and/or machining accuracy may be reduced.

In documents EP3770697A1, EP4004654A1, CH716430A2, EP3770698A1, EP4004653A1, and CH716431A2, processes are described for manufacturing a watch jewel, with and without a hole, respectively, comprising a step of ultra-short-pulse laser ablation with a duration of less than 100 ps. The laser beam is scanned using a 3-axis precession system to cancel and/or control the taper of the machined flanks.

### SUMMARY OF THE INVENTION

The purpose of the invention is to provide a laser machining system capable of overcoming the current limitations associated with the use of moving optics, particularly in terms of the speed of laser machining by precession—which is limited by the precession speed and its circular trajectory—as well as in terms of controlling taper and roughness. Trajectories in closed shapes, such as a circle, an ellipse, or a polygon, or in open shapes, such as a spiral, can be achieved at high speed. The invention also aims to overcome some limitations on the power transmitted to the workpiece caused by optics incorporating multiple refractive elements. The invention also enables flexible laser machining, allowing for an almost instantaneous switch between a precession machining mode and conventional machining without precession.

A laser machining system according to the invention is defined by point 1 below.
1. A system for laser machining a component, in particular a timepiece component, specifically a system for laser cutting a component, the system comprising:
   a source for emitting a pulsed laser beam,
   a first subsystem for adjusting the polarization of the laser beam, in particular a half-wave plate,
   at least a first and a second deflector, in particular a first and a second acousto-optic deflector or a first and a second electro-optic deflector, having non-parallel axes, in particular with perpendicular axes,
   a second polarization adjustment subsystem for the beam exiting the deflectors, in particular one or two quarter-wave plates,
   a deflector control subsystem, in particular a controllable radiofrequency generator,
   a subsystem for synchronizing the laser beam emission source with the control subsystem, in particular an adjustable delay generator,
   a first focusing subsystem comprising a first lens and positioned after the second subsystem for adjusting the polarization of the beam exiting the deflectors,
   a subsystem for simultaneously controlling the divergence and deflection of the laser beam at the output of the deflectors, comprising (i) a second focusing subsystem, in particular a first telescope (RF), and (ii) a propagation module, the subsystem for simultaneously controlling divergence and deflection being positioned between the output of the deflectors and the first focusing subsystem, and
   a beam stabilization subsystem positioned downstream of the laser source and/or upstream of a first deflector,
   the system being configured to create a precession of the laser beam.

Various embodiments of the laser machining system according to the invention are defined by points 2 to 12 below.
2. The system as defined in point 1, wherein the system comprises a laser beam diameter enlarger, in particular a second telescope.
3. The system as defined in point 2, wherein the beam stabilization subsystem is positioned between the enlarger and the input of the first deflector.
4. The system as defined in one of the preceding points, wherein the first focusing subsystem comprises a scanner head including two galvanometer mirrors.
5. The system as defined in point 4, wherein the system comprises a control subsystem arranged to synchronize:
   the deflectors, and
   the scanner head,
   in order to obtain a controlled taper of machining flanks depending on the position on a machining contour of the component by adjusting a precession diameter of the laser beam.
6. The system as defined in one of points 1 to 5, wherein the first focusing lens is an F-theta-telecentric lens.
7. The system as defined in one of points 1 to 3, wherein the first focusing subsystem comprises:
   compressed gas ejection nozzles, in particular compressed air nozzles, for removing machining products from the focal point of the first lens, and
   a table for moving the component along two axes, or along three axes, or along four axes, or along five or more axes relative to the first lens.
8. The system as defined in one of the preceding points, wherein the second focusing subsystem is configured to produce a divergent portion of the laser beam beyond an intermediate focusing point.
9. The system as defined in one of the preceding points, wherein the second focusing subsystem is a first telescope comprising lenses having different focal lengths, in particular a first focal length of about 150 mm and a second focal length of about-100 mm.
10. The system as defined in one of the preceding points, wherein the deflectors are configured to make the laser beam describe an annular shape, in particular a circular shape, in a plane perpendicular to an optical axis.
11. The system as defined in one of the preceding points, wherein the deflector control subsystem controls the energy and emission of a laser pulse with control of the deflectors, in particular control of the excitation of acoustic waves of the acousto-optical deflectors or control of the refractive index of the electro-optical deflectors, in order to adjust the intensity of the laser beam at the output of the deflectors.
12. The system as defined in one of the preceding points, wherein the synchronization subsystem allows synchronization of the control subsystem, notably with a laser clock, so as to control the change in deflection of the deflectors between two successive laser pulses.

A laser machining process according to the invention is defined by point 13 below.
13. A laser machining process, in particular a laser cutting process, for a component, in particular a timepiece component, comprising the following steps:
   a first step of adjusting laser parameters based on the material of the component to be machined and the desired roughness of the machined flanks, in particular the pulse frequency, the energy and duration of the laser pulses, to achieve an ablation depth of 1 to 20 μm, preferably 1 to 10 μm, more preferably 2 to 5 μm, in a single pass,
   a second step of adjusting the laser beam divergence control system at the output of the deflectors, in particular the distance between lenses of a telescope, to obtain
   (i) a distance between the focal point of the laser beam and a reference point, in particular a first lens, upstream of the focal point of the laser beam
   that is longer than
   (ii) a distance between the apex of a precession cone and the reference point, in particular the first lens, upstream of the apex of a precession cone,
   depending on the material of the component to be machined and the desired inclination of the machined flanks,
   a third step of adjusting the feed rate of the laser beam on a machining plane based on a precession speed of the laser beam obtained by the action of the deflectors,
   a fourth step of laser machining the component using the parameters determined in the first, second, and third steps.

Embodiments of the process according to the invention are defined by points 14 and 15 below.
14. The process as defined in point 13, the process comprising the use of a system as defined in one of points 1 to 12.
15. The process as defined in one of points 13 and 14, wherein a simultaneous control of the divergence and of the deflection of the laser beam allows independent adjustments of:
   the position of the focal point of the laser beam, and
   the position of the apex of a precession cone.

### BRIEF DESCRIPTION OF THE DRAWINGS

The figures show, by way of example, an embodiment of a laser machining system according to the invention.

FIG. 1 is a schematic explanatory view of the principle of laser machining with precession.

FIG. 2 is a schematic explanatory view of the operating principle of an acousto-optic deflector.

FIG. 3 is a block diagram of an embodiment of a laser machining system according to the invention.

FIG. 4 is a schematic view of an embodiment of the laser machining system according to the invention.

FIG. 5 is a diagram representing the envelope shape of a precessing laser beam in the absence of a divergence control system.

FIG. 6 is a diagram representing the envelope shape of a precessing laser beam with the implementation of a divergence control system.

FIG. 7 is a table summarizing parameters enabling a machining process according to the invention.

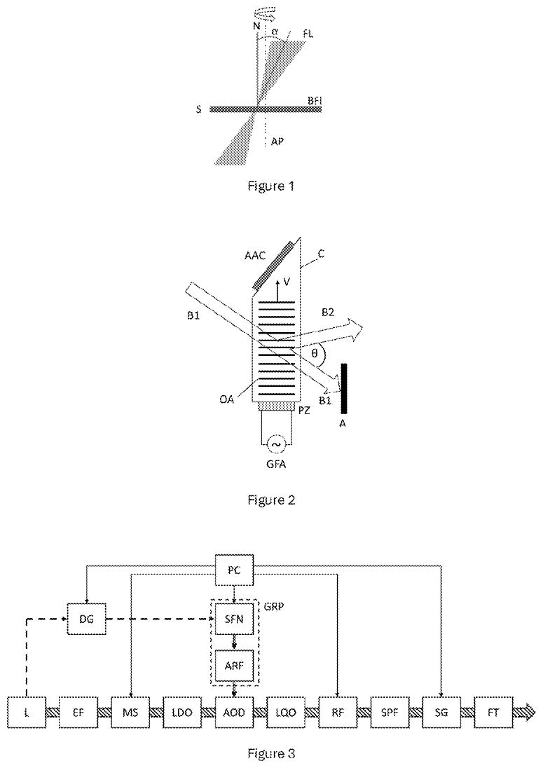

### DETAILED DESCRIPTION OF PARTICULAR EMBODIMENTS

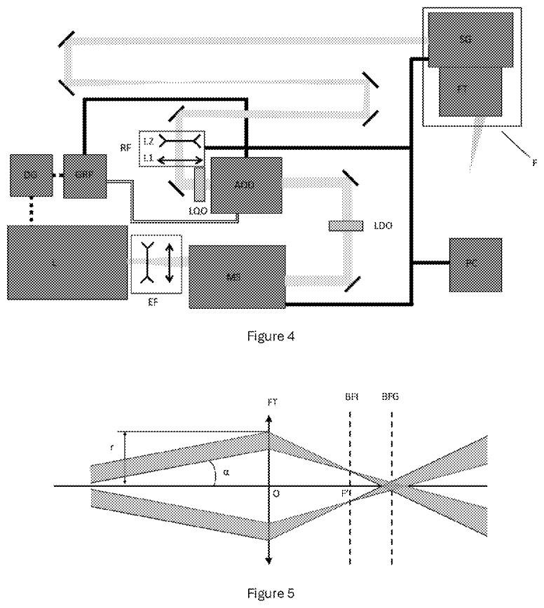

An embodiment of system 1 is described below with reference to FIGS. 3 to 7. The laser machining system may, in particular, be a laser cutting or laser engraving system.

The system 1 advantageously enables the laser machining of any component, including timepiece components or non-timepiece components.

The system 1 comprises:
a laser source L for emitting a pulsed laser beam,
a first subsystem LDO for adjusting the polarization of the laser beam, in particular a half-wave plate LDO,
at least a first and a second deflector, in particular a first and a second acousto-optic deflector AOD or a first and a second electro-optic deflector, having non-parallel axes, in particular with perpendicular axes,
a second subsystem LQO for adjusting the polarization of the beam emerging from the deflectors, in particular one or two quarter-wave plates LQO for converting the linear polarization of the laser beam into circular polarization,
a deflector control subsystem, in particular a controllable radiofrequency generator GRP that can be implemented either by a digital frequency synthesizer or by a voltage-controlled oscillator, controlling the energy and emission of a laser pulse with control of the deflectors, in particular, control of the acoustic wave excitation of the acousto-optic deflectors or control of the refractive index of the electro-optic deflectors, in order to adjust the intensity of the laser beam at the output of the deflectors,
an adjustable delay generation subsystem DG, enabling the GRP to be synchronized with the laser clock so as to control the change in deflection of the AODs between two successive laser pulses, or a synchronization subsystem DG for synchronizing the laser beam emission source with the control subsystem GRP,
a first focusing subsystem F comprising a first lens FT and positioned after the second subsystem LQO for adjusting the polarization of the beam exiting the deflectors,
a subsystem for simultaneously controlling the divergence and linear deflection of the laser beam at the output of the deflectors, and
a beam stabilization subsystem MS positioned downstream of the laser source and/or upstream of a first deflector.

Preferably, the system is configured to create a precession of the laser beam.

In addition, the subsystem for simultaneously controlling the divergence and linear deflection of the laser beam comprises:
a second focusing subsystem RF, such as a first telescope RF, and
a propagation module SPF of necessary length to achieve:
(a) a first lens FT to beam focal point distance (distance between the BFI plane and a reference point O upstream of the BFI plane) longer than the first lens FT to precession cone apex distance (distance between the BFG plane and the reference point O upstream of the BFG plane), and
(b) a predefined precession ring diameter.

Furthermore, the subsystem for simultaneously controlling divergence and linear deflection is positioned between the output of the deflectors and the first focusing subsystem FT.

In the embodiment of the laser machining system illustrated and described in more detail, the deflectors are acousto-optic deflectors (hereinafter AOD deflectors or AOD).

In this embodiment, to produce a precessing beam, acousto-optic deflectors are used, as described below with reference to FIG. 2. The excitation of acoustic waves OA in a crystal C by a piezoelectric element PZ, driven by a radiofrequency electrical generator GRF, creates an in-phase grating of which the propagation speed is that of sound in the material. Due to the acousto-optic effect, the refractive index of the material is periodically modulated by regions of compression and expansion produced by the acoustic waves. The incident laser beam B1 is diffracted by this moving grating. The diffracted beam B2 has a diffraction angle θ relative to the direction of the incident beam B1. The angle θ is approximated by the relation:

θ=(λ×f_{RF})/V,
where:
λ is the wavelength of the laser beam,
f_{RF} is the frequency of the acoustic waves, and
V is the speed of these waves.

The diffraction angle can therefore be modified by changing the acoustic frequency. However, the maximum angular amplitude is not high, typically in the order of 1°.

Preferably, the undiffracted beam B1 is not used and is blocked by an absorber A. Typically, up to 90% of the energy of the incident beam B1 can be converted into beam B2.

Advantageously, each AOD also includes an acoustic wave absorber AAC.

AODs are advantageously combined in pairs with their deflection directions orthogonal to one another. This allows the beam to be directed in two dimensions, and particularly in precession to form a precessing beam.

When the deflectors are of the AOD type, the amplitude and frequency of the acoustic waves are adjusted according to the desired diffraction angle and laser beam intensity.

When the deflectors are of the EOD type, the amplitude of the deflector drive voltage is varied depending on the refraction angle to be achieved.

To achieve the fastest possible laser machining with femtosecond pulses, with the laser driven in a precession motion, it is necessary to ensure adequate overlap between the precession circles. These circles are generated by the action of the acousto-optic deflectors, while the laser machining system also includes a galvanometer system SG (scanner head) that provides the machining feed movements. Thus, the large working area achievable by the machining is ensured by the SG galvanometer system. This principle requires maximizing the precession speed in order to fully utilize the maximum scanning speed of the galvanometric system.

The use of acousto-optic deflectors (AODs) generally increases the addressing speed in the working plane, and consequently the precession frequency, particularly due to their response time of approximately 1 μs (a duration corresponding to the propagation of sound across the beam diameter), as opposed to the millisecond range achievable with mechanical rotary systems. However, to improve the exploitation of AODs, specific measures are advantageously employed:
a) the nonlinear effects caused by high-intensity laser pulses are reduced,
b) the variability of the diffracted light intensity, which depends on the diffraction angle and polarization, is compensated for,
c) due to a diffraction angle limited to approximately 1°, a system is implemented capable of converting the angular deflection of the laser beam into a linear displacement in the plane perpendicular to the beam, preferably of approximately 10 mm,
d) the incident beam is stabilized in view of the small deflection angle and the restricted aperture of the AOD, which is generally on the order of 5 mm,
e) a control system PC is implemented to control the focal point of the precessing beam in order to achieve a desired taper during laser machining.

In a variant, the addressing along the contour, which may be closed or open, is followed by the machining system in a random or continuous manner in order to optimize flank roughness and thermal load.

The use of an AOD is limited by laser damage and laser repetition rate. The crystals in the AOD are made of quartz, a dielectric with a high damage threshold fluence. For a single pulse at 515 nm and a pulse duration of 500 fs, the damage threshold is estimated to be approximately 2.5 J/cm⁻² in silica. However, due to incubation effects, this threshold drops to approximately 0.6 J/cm⁻² after 100,000 pulses. Since the AOD has a maximum aperture of 7 mm, the maximum energy per pulse is estimated at 230 mJ. Consequently, assuming a damage threshold that remains roughly stable beyond 100,000 pulses at approximately 0.6 J/cm⁻², the AOD can be used safely with current industrial lasers with a power of 300 W and a pulse frequency in the range of 0.1 MHz to 1 MHz.

The maximum usable laser repetition rate is limited by the speed of sound in the AOD crystal and the beam size. For a beam diameter of 7 mm, the maximum frequency is estimated at 814 kHz based on the time required for the acoustic waves to traverse this distance at a speed of approximately 5,700 m·s⁻¹.

The control subsystem includes a delay generator DG that synchronizes the excitation of acoustic waves in the AODs with the arrival of a laser pulse to create a diffractive grating, thereby optimizing the intensity of the diffracted light. This subsystem also adjusts the diffraction efficiency based on the acoustic intensity. This control allows the intensity of the laser beam to be uniformized along its annular trajectory in the plane perpendicular to the system's optical axis, particularly when it follows a circular path, ensuring homogeneous ablation of the material throughout the machining process. In one embodiment, the control may be based on a lookup table that associates diffraction angle values with specific acoustic frequencies and intensities. In another embodiment, the intensity of the laser pulses at the source output can be adjusted according to the diffraction angle to ensure uniform beam intensity along the path downstream of the AODs.

To compensate for deviations, particularly those caused by thermal fluctuations of the beam at the output of the laser source L, the MS laser beam stabilization subsystem is advantageously integrated upstream of the AODs. Thus, the laser beam stabilization subsystem MS can be positioned between the enlarger EF and the input of the first acousto-optic deflector (AOD). This subsystem also advantageously reduces the waiting time before machining due to laser warm-up after power-on.

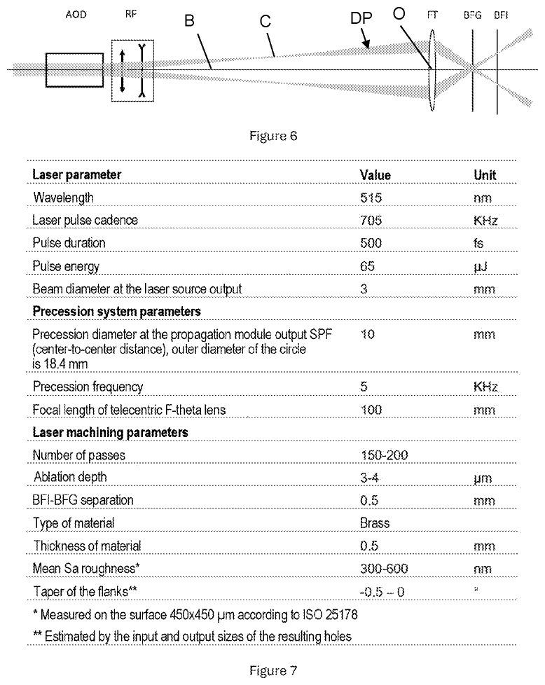

After passing through the AODs, the laser beam, which follows an annular trajectory, is focused by a first focusing subsystem F, in particular, by a telecentric F-theta lens, which has the advantage of maintaining the size of the focal spot across the entire working field and minimizing aberrations. Since the beam divergence is less than the deflection angle of the AODs in annular trajectory mode, the beam is focused before the apex of the precession cone. As illustrated in FIGS. 5 and 6, the BFG (Best Focus Global) plane is the plane perpendicular to the optical axis where the smallest cross-sectional dimension of the virtual intersection of the precessing laser beam is formed, which is very close to the apex of the cone formed by the precessing laser beam. It is essential to perform material machining beyond the apex of the precession cone (downstream of the BFG plane) to obtain flanks with zero or negative taper. The BFI plane (for “Best Focus Individual”) is the plane perpendicular to the optical axis where the laser beam is focused. If the beam is properly collimated, the BFI plane coincides with the focal plane of the lens.

Early focusing of the laser beam, illustrated in FIG. 5, prevents optimal precession machining. The width of the cutting groove widens significantly beyond the BFG plane (compared to a beam without precession), which requires more powerful pulses and compromises precision. This increases the risk of overheating the material being machined and degrading the quality of the flanks.

The difference A between the BFI and BFG planes is given by the following equation:

$$Δ = BFG - BFI = f / ( r / ( f \times tan α ) - 1 ) ,$$

where
f is the focal length of the focusing subsystem F,
r is the radius of the beam circle at the entrance to the focusing subsystem F,
α is the angle between the laser beam and the precession axis (the optical axis).

For typical values of:
a focal length of 100 mm,
angle α between 0.1° and 1°, and
radius r of 10 mm,
   a value of Δ between 1 and 20 mm is obtained. This is unfavorable, as the BFG plane is always located downstream of the BFI plane.

To remedy this situation, the laser machining system advantageously includes a second focusing subsystem RF, specifically a first, slightly focusing telescope, positioned downstream of the AODs. By adjusting the distance between lenses L1 and L2 of the second focusing subsystem RF, it is possible to modify the beam divergence by slightly focusing it and utilizing its divergent portion beyond the focal point. To prevent optical breakdown at this intermediate focal point, soft focusing is essential. This is characterized by a long effective focal length. Advantageously, this long distance is also used to increase the beam scanning radius by the AODs. Positioning the subsystem RF at the output of the AODs places the deflection focus near the center of the positive lens, which leaves unchanged or slightly modifies the deflection angle required for precession. The situation is reversed with regard to beam divergence, thus allowing precise adjustment of the distance between the BFI and BFG planes to form an optimal focal point for precession machining with controlled taper.

In FIGS. 5 and 6, the beam divergence angles are exaggerated for ease of understanding.

The first focusing subsystem FT, comprising a telecentric F-theta lens in a scanner head, offers two main advantages for achieving straight flanks in precession laser machining. The first advantage is that the average angle of incidence for each laser beam remains perpendicular to the surface of the machined component both at the center and at the edges of the machinable field. This prevents a loss of machining homogeneity caused by the cos(θ)⁴ law (which defines an attenuation of the beam's energy as a function of the beam's angle of incidence θ). A second advantage, stemming from the first, is a beam focus shape that remains constantly circular even in the machining depth. In the event of vertical displacement during machining, this ensures the stability of the angle of incidence and thus the consistency of the flank inclination, as well as the quality of their surfaces.

By contrast, a scanner head equipped with a standard F-theta lens during laser machining can cover a larger working area than a telecentric F-theta lens. However, the angle of incidence of the rays varies: it is perpendicular to the work plane at the center but gradually tilts toward the edges. Consequently, a standard F-theta lens cannot maintain the normal incidence of the laser beam in the event of lateral and vertical shifts, nor across the entire work surface. Furthermore, the shape of the focal point is distorted into an ellipse outside the center of the work plane, making it difficult, if not impossible, to achieve flanks with constant inclination via laser beam precession using a non-telecentric lens. Indeed, the angle of incidence becomes dependent on the position of the machining point on the work plane and the machining depth.

FIGS. 3 and 4 schematically illustrate the precession-based laser machining system with controlled taper according to one embodiment. This system comprises a laser source L which, via the delay generator DG, synchronizes the excitation of the acousto-optic deflectors AOD. The beam emerging from the laser source is enlarged by a telescope EF before entering the stabilization subsystem MS. After passing through the stabilization subsystem MS, the beam's polarization is adjusted by the first laser beam polarization adjustment subsystem LDO to maximize the diffraction efficiency of the AODs. The linear polarization of the beam after the AODs is converted to circular polarization by the second sub-system LQO for adjusting the polarization of the beam exiting the acousto-optic deflectors. Next, the beam divergence is modified by the subsystem for simultaneous control of the divergence and linear deflection of the laser beam, including the first telescope. The beam propagation module SPF provides the necessary path length to adjust its divergence and also to convert the angular deflection into a linear deflection before the beam enters the first focusing subsystem F. This first focusing subsystem F comprises galvanometer mirrors SG and the first telecentric F-theta focusing lens FT.

The laser source L can be associated with a frequency doubler. The laser source L can thus deliver pulses with durations ranging from 10 fs to 10,000 fs, at a repetition rate of 100 KHz to 1 MHz, with a pulse energy of 1 μJ to 200 mJ, a wavelength of 300 nm to 2,000 nm, and a beam diameter of 1 to 10 mm.

The EF telescope preferably increases the beam diameter from 3 mm to 5 mm, thereby allowing for better utilization of the 7 mm total aperture of the AODs.

The subsystem for simultaneously controlling the divergence and linear deflection of the laser beam comprises the RF telescope. The telescope comprises, for example, two lenses, L1 and L2, with focal lengths of 150 mm and −100 mm, respectively. They can be positioned approximately 40 mm apart on a motorized axis, which allows this distance to be adjusted via the control subsystem PC.

The divergence obtained after passing through the RF telescope is 0.1 to 5 milliradians, typically 1 to 2 milliradians. The diameter of the beam without precession is 3 mm to 18 mm at the entrance to the SG galvanometer system. The diameter of the precession circle can be set from 0.1 to 20 mm. Thus, the outer diameter of this circle is approximately 3 to 38 mm at the entrance to the first F focusing subsystem, with typical values of 10 to 20 mm. The total beam propagation distance between the RF telescope output and the input of the SG galvanometric system is approximately 3 to 10 m, typically 5 to 7 m.

The first F-focusing subsystem is shown in FIG. 4. The first F-focusing subsystem may comprise:
a scanner head SG comprising two galvanometric mirrors, specifically capable of receiving a beam up to 40 mm in diameter, typically 20 to 30 mm, and
a telecentric F-theta lens FT, in particular with a focal length of 100 mm.

The beam scanning speed can vary between 8 and 14 m/s. The distance between the BFG plane and the BFI plane can range from 10 to 5000 μm, typically between 100 and 500 μm, depending on the beam's divergence and AOD deflection values.

An example of possible machining parameters is given in the table in FIG. 7.

Various parameters control the machining taper and the roughness of the flanks according to the process of the invention or when using a machining system according to the invention:
The number of passes. With more passes, the taper becomes more negative up to a certain limit that depends on the ablation threshold. The ablation threshold by a laser pulse, for a given material, depends on the wavelength, pulse duration, pulse energy, and energy intensity (J/cm⁻²) on the material's surface. The latter is determined by the focusing means, typically a lens.
The ring diameter described by the laser beam deflected by the AODs. This diameter defines the angle of the precession cone or the angle of attack. The larger the diameter, the more negative the taper at a given focal length of the focusing lens.
The number of laser pulses around the circumference of the ring described by the laser beam deflected by the AODs. This number ranges from 1 to 10,000, typically between 1 and 1,000.
The focal length of the F-theta lens and the precession cone diameter, which is given by the deflection of the AODs, define the angle of incidence on the material to be machined.
The roughness of the flanks depends on the number of passes and the type of beam path. It decreases as the number of passes increases, as well as with the uniformization of machining by creating a beam path with the most uniform focal point overlap possible and without repetitive patterns. To achieve this, precession (rotation of the laser beam via the AODs) is alternated between clockwise and counterclockwise directions. Non-sequential addressing—for example, random addressing—of points on the circumference of the precession ring also reduces roughness.

The taper can be controlled using two distinct machining modes. In the first mode, the angle of deflection of the laser beam by the AODs is constant to form a ring with a constant final diameter. In this first mode, the taper does not vary along the component's machining path, and the control of the laser beam by the scanner head is not synchronized with the angle of deflection by the AODs.

In the second mode, a taper value is assigned to each position along the component's machining contour. The position of the scanner head, which traces the contour of the component—particularly the timepiece component—is used to calculate the deflection required by the AODs to create a suitable precession cone. Consequently, the scanner head is synchronized with the AODs. This synchronization is performed by a control subsystem PC.

In the context of the invention, tests have demonstrated that, with a focal length of the F-theta lens of 100 mm, the flank taper range was +5°. By changing the focal length to 50 mm, this range was expanded to +10°.

Materials suitable for laser machining by precession according to the present invention include:
metals,
metal alloys,
ceramics,
glasses,
polymers, and
combinations of these, particularly in the form of composites.

These materials may be crystalline, particularly polycrystalline, or non-crystalline, particularly amorphous, natural, or synthetic. Examples of polycrystalline and crystalline materials include metal alloys, semiconductors, ceramics, cermets, sapphire, and ruby. Examples of amorphous materials include mineral glasses and amorphous metal alloys.

The wavelength of the laser source is selected based on the absorption of the material to be machined. Typically, metals can be machined well with all practical wavelengths between 2 μm and 300 nm. Wavelengths from 300 nm to 600 nm are preferred for transparent or translucent materials, as well as for metals, due to the higher machining precision.

Regardless of the embodiment or variant, the AODs can be made from crystalline quartz SiO₂. Alternatively, other acousto-optic materials can be used for AODs, for example:
tellurium oxide TeO₂,
potassium niobate KNbO₃,
lithium niobate LiNbO₃,
lithium tantalate LiTaO₃, or
lead molybdate PbMoO₄.

Regardless of the embodiment or variant, electro-optical deflectors (EODs) can be used as an alternative to AODs. In these deflectors:
electro-optical effects, notably the Pockels effect or the linear electro-optical effect (proportional to the electric field intensity), and
the Kerr effect or the quadratic electro-optical effect, can also be utilized in the construction of electro-optical deflectors. An advantage of such EODs is the absence of an undeviated beam, which eliminates the need for a cooled absorber to absorb the undeviated beam. This allows for the creation of more compact deflectors that do not require water cooling.

There are two main configurations for constructing an electro-optic deflector. The first configuration utilizes refraction at the faces of a prism. The second configuration utilizes refraction due to a gradient in the refractive index perpendicular to the direction of propagation of a laser beam. In both configurations, the electric field is applied perpendicular to the direction of light propagation.

Similar to acousto-optic deflectors, electro-optic deflectors exhibit similar deflection characteristics, with a deflection frequency in the range of 1 to 100 MHz and an amplitude in the range of 0.1° to 1°.

Materials suitable for fabricating Pockels-effect electro-optic deflectors include, for example:
lithium niobate LiNbO₃,
lithium tantalate LiTaO₃,
potassium dihydrogen phosphate (KDP) KH₂PO₄ and its deuterated variant (DKDP) KD₂PO₄,
hydrothermally synthesized potassium triphosphate (HGKTP) K₃PO₄,
beta barium borate (BBO) β-BaB₂O₄,
potassium titanyl phosphate KTiOPO₄.

Regardless of the embodiment or variant, as an alternative to the galvanometric system of the scanner head SG (galvanometric mirrors), a combination of a table capable of translations in two non-parallel directions (XY) and a focusing lens, in particular a telecentric lens integrated into the focusing subsystem F, may be used. In this embodiment, the machining path is achieved by translations of the XY table rather than by scanning the laser beam via the orientation of the galvanometric mirrors. This embodiment allows for the creation of a laser machining head with improved removal of machining waste, resulting in better cutting quality, thanks to an integrated compressed gas nozzle system.

Regardless of the embodiment or variant, the first focusing subsystem may be a scanner head comprising two SG galvanometric mirrors and a telecentric F-theta lens FT. Regardless of the embodiment or variant, the first focusing subsystem may include compressed gas nozzles, in particular compressed air nozzles, to remove cutting products from the focal point of the lens.

Regardless of the embodiment or variant, the machining system may include a translation table with two axes, or three axes, or four axes, or five axes or more, in order to move the machined component relative to the laser beam. Such a table may be used as a replacement for or in addition to a scanner head (with galvanometric mirrors or a two-axis translation table).

Regardless of the embodiment or variant, a control subsystem PC allows the deflectors and the scanner head to be synchronized in order to achieve a controlled taper of the flanks according to the position on the component's machining contour by adjusting the precession diameter of the laser beam.

Regardless of the embodiment or variant, a laser beam stabilization module typically comprises motorized biaxial mirrors driven by stepper motors, servo motors, or piezoelectric actuators. These actuators can be controlled by an electronic system in a closed-loop or open-loop configuration to maintain the beam's angular and linear position stable, using the beam's position relative to two position sensors-such as a quadrant photodiode or an imaging camera—as a reference. These sensors can typically be positioned behind two partially transparent mirrors arranged along the beam's propagation axis.

Regardless of the embodiment or variant, when controlling AOD via a programmable frequency synthesizer, a sequence of frequencies and amplitudes corresponding respectively to beam deflections and laser intensities is advantageously stored in memory in an LUT (look-up table). A clock edge from the laser system is sent to an input of the frequency synthesizer to trigger the transition from one set of LUT values to the next. To ensure that the transient response triggered by this change in frequency and amplitude does not disrupt the laser beam, the beam is synchronized between two successive laser pulses. This synchronization is ensured by the proper adjustment of an adjustable delay generator DG. The LUT values and delay values are transmitted to the generator by the control computer PC. The delay generator can be used in master mode or slave mode relative to the scanner head.

The invention also relates to a laser machining process, a process for carrying out which is described below. Such a machining process can be implemented by a laser machining system as described above. The laser machining process allows a component, in particular a timepiece component, to be machined.

The machining process comprises the following steps:
a first step E1 of adjusting laser parameters based on the material of the component, particularly the timepiece component, to be machined and the desired roughness of the machined flanks, specifically the pulse frequency, energy, and duration of the laser pulses, the path pattern, to achieve an ablation depth of 1 to 20 μm, preferably 1 to 10 μm, and even more preferably 2 to 5 μm, in a single pass,
a second step E2 for adjusting the laser beam divergence control system at the output of the acousto-optic deflectors (AODs), specifically the distance between the RF telescope lenses, to obtain
(i) a distance between the focal point of the laser beam (or BFI plane) and a reference point O, such as the FT lens, upstream of the focal point of the laser beam
that is longer than
(ii) a distance between the apex of the precession cone (or BFG plane) and the reference point O, such as the FT lens, upstream of the apex of the precession cone,
depending on the material of the component to be machined and the desired inclination of the machined flank,
a third step E3 of adjusting the feed rate of the laser beam on a machining plane based on a precession speed of the laser beam obtained by the action of the acousto-optic deflectors AOD,
a fourth step E4 of laser machining the component, in particular the timepiece component, using the parameters determined in the first, second, and third steps.

The solutions described above make it possible to reduce the machining or cutting time for components with straight flanks, particularly in the watchmaking industry, by a factor of ten compared to existing solutions. According to the invention, the machining system has no moving parts, particularly rotating ones, to create the precession of the laser beam. The precession is in fact achieved using deflectors, particularly AODs or EODs. Scanning in directions transverse to the laser beam is achieved using galvanometer mirrors (scanner head).

The process of the invention can be used for the laser machining of timepiece components such as movement or case components. A non-exhaustive list of movement components includes toothed components, in particular a gear wheel, a pinion, an escape wheel, an anchor, and a balance rim; elastic return components such as a spring; as well as other movement components such as a cam, a rocker, a lever, a jewel, a mainplate, or a bridge. The non-exhaustive list of case components includes a dial, an appliqué, a hand, a crown, a bezel, a bezel disk, a crystal, a case back, a case, as well as wristlet components such as a clasp blade or a link.

1. A system for laser machining a component, the system comprising:
a source for emitting a pulsed laser beam,
a first subsystem for adjusting a polarization of the laser beam,
at least a first and a second deflector, having non-parallel axes,
a second polarization adjustment subsystem for the laser beam exiting the deflectors,
a deflector control,
a subsystem for synchronizing the laser beam emission source with the control subsystem,
a first focusing subsystem comprising a first lens and positioned after the second subsystem for adjusting the polarization of the laser beam exiting the deflectors,
a subsystem for simultaneously controlling a divergence and deflection of the laser beam at an output of the deflectors, comprising (i) a second focusing subsystem, and (ii) a propagation module, the subsystem for simultaneously controlling divergence and deflection being positioned between the output of the deflectors and the first focusing subsystem, and
a beam stabilization subsystem positioned downstream of the laser source and/or upstream of a first deflector,
the system being configured to create a precession of the laser beam.

2. The system as claimed in claim 1, wherein the system comprises a laser beam diameter enlarger.

3. The system as claimed in claim 2, wherein the beam stabilization subsystem is positioned between the enlarger and an input of the first deflector.

4. The system as claimed in claim 1, wherein the first focusing subsystem comprises a scanner head including two galvanometer mirrors.

5. The system as claimed in claim 4, wherein the system comprises a control subsystem arranged to synchronize:
the deflectors, and
the scanner head,
in order to obtain a controlled taper of machining flanks depending on a position on a machining contour of the component by adjusting a precession diameter of the laser beam.

6. The system as claimed in claim 1, wherein the first focusing lens is an F-theta-telecentric lens.

7. The system as claimed in claim 1, wherein the first focusing subsystem comprises:
compressed gas ejection nozzles for removing machining products from a focal point of the first lens, and
a table for moving the component along two or more axes relative to the first lens.

8. The system (Has claimed in claim 1, wherein the second focusing subsystem is configured to produce a divergent portion of the laser beam beyond an intermediate focusing point.

9. The system as claimed in claim 1, wherein the second focusing subsystem is a first telescope comprising lenses having different focal lengths.

10. The system as claimed in claim 1, wherein the deflectors are configured to make the laser beam describe an annular shape in a plane perpendicular to an optical axis.

11. The system as claimed in claim 1, wherein the deflector control subsystem controls an energy and emission of a laser pulse with control of the deflectors, in order to adjust an intensity of the laser beam at the output of the deflectors.

12. The system as claimed in claim 1, wherein the synchronization subsystem allows synchronization of the control subsystem, so as to control a change in deflection of the deflectors between two successive laser pulses.

13. A laser machining process for a component, the process comprising:
adjusting laser parameters based on a material of the component to be machined and a desired roughness of machined flanks, to achieve an ablation depth of 1 to 20 μm in a single pass,
adjusting a laser beam divergence control system at an output of the deflectors, to obtain
(i) a distance between a focal point of the laser beam and a reference point upstream of the focal point of the laser beam
that is longer than
(ii) a distance between an apex of a precession cone and the reference point upstream of the apex of the precession cone,
depending on the material of the component to be machined and the desired inclination of the machined flanks,
adjusting a feed rate of the laser beam on a machining plane based on a precession speed of the laser beam obtained by an action of the deflectors, and
machining the component using the parameters determined in the first, second, and third adjusting.

14. The process as claimed in claim 13, the process comprising using a system comprising:
a source for emitting a pulsed laser beam,
a first subsystem for adjusting a polarization of the laser beam,
at least a first and a second deflector, having non-parallel axes,
a second polarization adjustment subsystem for the laser beam exiting the deflectors,
a deflector control subsystem,
a subsystem for synchronizing the laser beam emission source with the control subsystem,
a first focusing subsystem comprising a first lens and positioned after the second subsystem for adjusting the polarization of the laser beam exiting the deflectors,
a subsystem for simultaneously controlling a divergence and deflection of the laser beam at an output of the deflectors, comprising (i) a second focusing subsystem, and (ii) a propagation module, the subsystem for simultaneously controlling divergence and deflection being positioned between the output of the deflectors and the first focusing subsystem, and
a beam stabilization subsystem positioned downstream of the laser source and/or upstream of a first deflector,
the system being configured to create a precession of the laser beam.

15. The process as claimed in claim 13, wherein the simultaneous control of the divergence and of the deflection of the laser beam allows independent adjustments of:
the position of the focal point of the laser beam, and
the position of the apex of a precession cone.

16. The system as claimed in claim 1, which is adapted for laser cutting a timepiece component.

17. The system as claimed in claim 1, wherein the first subsystem for adjusting the polarization of the laser beam is a half-wave plate.

18. The system as claimed in claim 1, wherein the first and second deflectors are a first and a second acousto-optic deflector, respectively, or a first and a second electro-optic deflector, respectively.

19. The system as claimed in claim 1, wherein the first and second deflectors have perpendicular axes.

20. The system as claimed in claim 1, wherein the second polarization adjustment subsystem for the laser beam exiting the deflectors includes one or two quarter-wave plates.
